(19) United States
(12) Patent Application Publication
(10) Pub. No.: US 2015/0081919 A1
(43) Pub. Date: Mar. 19, 2015

(54) CONTROL SYSTEM AND METHOD FOR CONTROLLING NETWORK CONNECTION OF ELECTRONIC DEVICES

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-GUO WU, Shenzhen (CN)

(21) Appl. No.: 14/489,483

(22) Filed: Sep. 18, 2014

(30) Foreign Application Priority Data
Sep. 18, 2013 (CN) 201310426938.5

(51) Int. Cl. H04L 29/06

(52) U.S. Cl. CPC H04L 65/1069
USPC 709/227

(57) ABSTRACT

A control system and method for controlling connections to networks includes a first electronic device and a second electronic device. The first electronic device used by a student or child includes a request unit and a connection control unit, the second electronic device which is used by a responsible person includes an answer unit. The request unit issues a request signal and sends the request signal to the second electronic device. The answer unit issues an answer signal and sends the answer signal to the first electronic device. The connection control unit controls the first electronic device to enable a connection to a network or to not enable a connection to a network, according to the answer signal.

### CROSS-REFERENCE TO RELATED APPLICATIONS

This application claims priority to Chinese Patent Application No. 201310426938.5 filed on Sep. 18, 2013, the contents of which are incorporated by reference herein.

### FIELD

The present disclosure relates to control systems for network connections.

### BACKGROUND

Electronic devices with network connection functions have been widely used in modern life.

### BRIEF DESCRIPTION OF THE DRAWINGS

The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a block diagram of an embodiment of a control system for controlling access to networks by an electronic device.

FIG. 2 is an interface shown on a display unit of the electronic device shown in FIG. 1.

FIG. 3 is a flowchart of an embodiment of a method for controlling network connections.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is described in relation to a control system and method for controlling connections to networks, the control system includes a first electronic device and a second electronic device. The first electronic device used by a student or child includes a request unit and a connection control unit, the second electronic device which is used by a responsible person includes an answer unit. The request unit issues a request signal and sends the request signal to the second electronic device. The answer unit issues an answer signal and sends the answer signal to the first electronic device. The connection control unit controls the first electronic device to enable a connection to a network or to not enable a connection to a network, according to the answer signal.

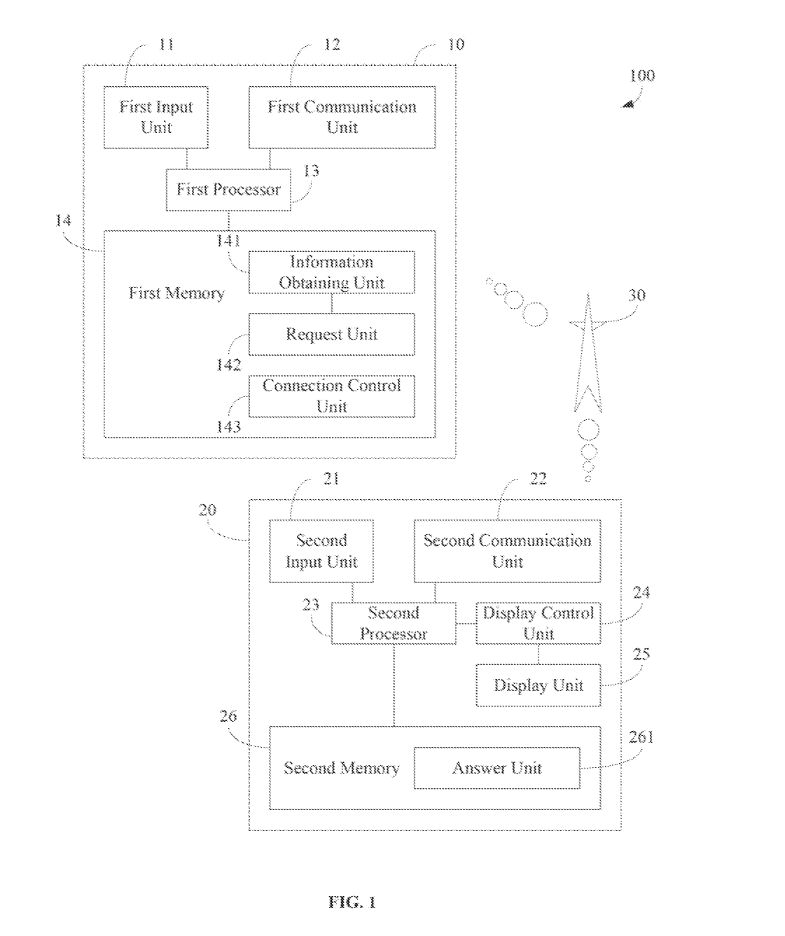

FIG. 1 illustrates an embodiment of a control system. The control system 100 can include a first electronic device 10 and a second electronic device 20. The first electronic device 10 communicates with the second electronic device 20 through a base station 30. The first electronic device 10 and the second electronic device 20 can be mobile terminals, mobile phones or tablet computers for example, and the first electronic device 10 can communicate with the second electronic device 20 by sending short messages.

The first electronic device 10 can include a first input unit 11, a first communication unit 12, a first processor 13 and a memory 14. The first processor 13 can execute instructions to provide functions of an information obtaining unit 141, a request unit 142, and a connection control unit 143. The instructions of the information obtaining unit 141, the request unit 142, and the connection control unit 143 are stored in the first memory 14.

The second electronic device 20 can include a second input unit 21, a second communication unit 22, a second processor 23, a display control unit 24, a display unit 25 and a second memory 26. The second processor 23 can execute instructions to provide functions of an answer unit 261. The instructions of the answer unit 241 are stored in the second memory 26.

The first input unit 11 of the first electronic device 10 issues a signal corresponding to an input operation of a user desiring a connection to a network, a student for example.

The information obtaining unit 141 of the first memory 14 obtains information of the first electronic device 10, a model and a name of the owner of the first electronic device 10 for example. Then the request unit 142 issues a request signal and sends the request signal to the second electronic device 20 through the first communication unit 12 and the base station 30. The request signal includes the information of the first electronic device 10 obtained by the information obtaining unit 141.

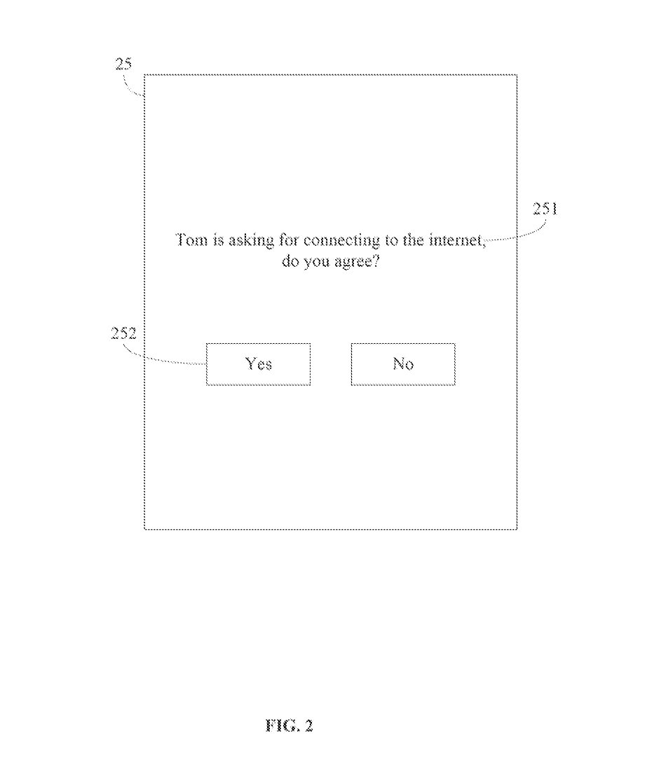

The second communication unit 22 of the second electronic device 20 receives the request signal, and the display control unit 24 controls the display unit 25 to display a message 251 to prompt a user to agree or not agree to connect the first electronic device 10 to the network and at least two associated options 252, which are shown in FIG. 2. In at least one embodiment, the displayed message 251 includes the information of the first electronic device 10 obtained by the information obtaining unit 141, and the at least two options 252 including a “Yes” option and a “No” option.

The second input unit 21 of the second electronic device 20 issues an option signal in response to a user's selection of one of the at least two options 252. In at least one embodiment, the user who selects one of the at least two options 252 is a responsible person such as a parent of the user of the first electronic device 10.

The answer unit 261 issues an answer signal corresponding to the option signal issued by the second input unit 21, then the answer unit 261 sends the answer signal to the first electronic device 10 through the second communication unit 22 and the base station 30. In at least one embodiment, the answer signal is selected from the group consisting of an approval signal and a rejection signal. When the option “Yes” is selected, the answer unit 261 issues the approval signal and sends the approval signal to the first electronic device 10. When the option “No” is selected, the answer unit 261 issues the rejection signal and sends the rejection signal to the first electronic device 10.

The first communication unit 12 of the first electronic device 10 receives the answer signal, and the connection control unit 143 controls the first communication unit 12 to enable the connection to the network or not enable the connection to the network, in accordance with the answer signal. In at least one embodiment, the connection control unit 143 controls the first connection unit 12 to connect to the network when the approval signal is received and the connection control unit 143 controls the first communication unit 12 to not enable a connection to the network when the rejection signal is received.

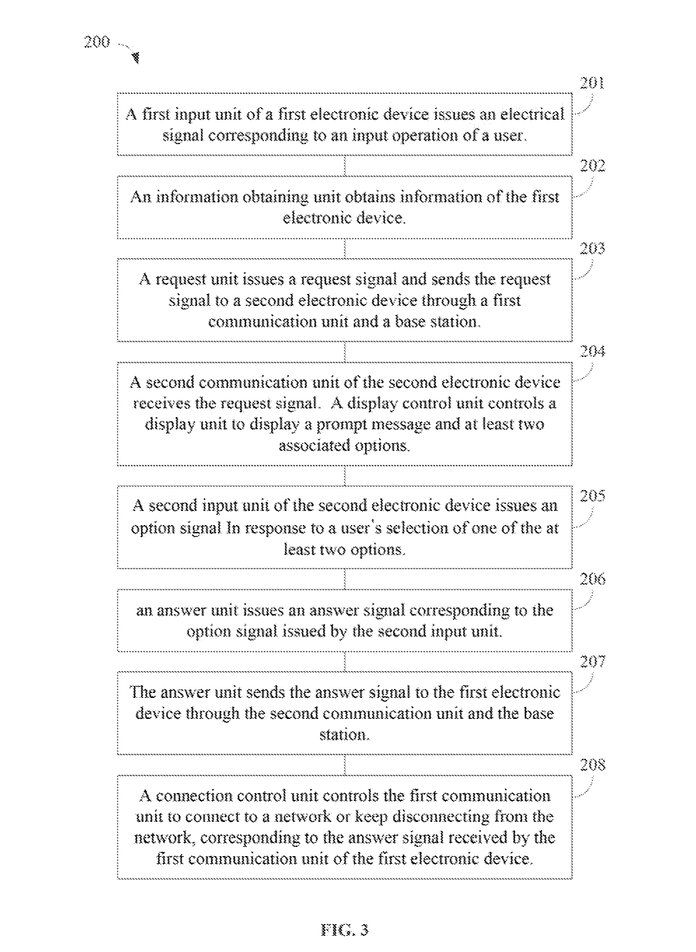

Referring to FIG. 3, a flowchart is presented in accordance with an example embodiment. A method 200 is provided by way of example, as there are a variety of ways to carry out the method. The method 200 described below can be carried out using the configurations illustrated in FIG. 1 and various elements of these figures are referenced in explaining example method 200. Each block shown in FIG. 2 represents one or more processes, methods, or subroutines, carried out in the exemplary method 200. Additionally, the illustrated order of blocks is by example only and the order of the blocks can be changed. The exemplary method 200 can begin at block 201.

At block 201, a first input unit of a first electronic device issues a signal corresponding to an input operation of a user. In at least one embodiment, the user can be a student.

At block 202, an information obtaining unit obtains information of the first electronic device. In at least one embodiment, the information of the first electronic device includes the model and the name of the owner of the first electronic device.

At block 203, a request unit issues a request signal and sends the request signal to a second electronic device through a first communication unit and a base station, the request signal includes the information obtained by the information obtaining unit.

At block 204, a second communication unit of the second electronic device receives the request signal. A display control unit controls a display unit to display a message to the user of the second electronic device including at least two associated options. In at least one embodiment, the message includes the information of the first electronic device obtained by the information obtaining unit, the at least two options include a “Yes” option and a “No” option.

At block 205, a second input unit of the second electronic device issues an option signal in response to the user's selection of one of the at least two options. In at least one embodiment, the user who selects one of the at least two options can be a responsible person.

At block 206, an answer unit issues an answer signal corresponding to the option signal issued by the second input unit. In at least one embodiment, the answer signal is selected from the group consisting of an approval signal and a rejection signal. When the option “Yes” is selected, the answer unit issues the approval signal; when the option “No” is selected, the answer unit issues the rejection signal.

At block 207, the answer unit sends the answer signal to the first electronic device through the second communication unit and the base station.

At block 208, a connection control unit controls the first communication unit to enable a connection to a network or not to enable a connection to a network, in accordance with the answer signal received by the first communication unit of the first electronic device. In at least one embodiment, the connection control unit controls the first connection unit to connect to the network when the approval signal is received and the connection control unit controls the first communication unit to not enable a connection to the network when the rejection signal is received.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A control system for controlling network connection of electronic devices, the control system comprising:
a first electronic device and a second electronic device, the first electronic device communicating with the second electronic device through a base station;
the first electronic device comprising:
a first processor configured to execute instructions of a request unit stored in a first memory, the request unit configured to issue a request signal and send the request signal to the second electronic device;
the second electronic device comprising:
a second processor configured to execute instructions of an answer unit stored in a second memory, the answer unit configured to issue an answer signal in response to a user's operation and send the answer signal to the first electronic device;
wherein the first electronic device further comprises a connection control unit configured to control the first electronic device to connect to a network or keep disconnecting from the network according to the answer signal.

2. The control system of claim 1, wherein the first electronic device further comprises an information obtaining unit, the information obtaining unit obtains information of the first electronic device, and the request signal comprises the information obtained by the information obtaining unit.

3. The control system of claim 2, wherein the second electronic device further comprises a display control unit, the display control unit controls a display unit to display a message which comprises the information obtained by the information obtaining unit, and at least two options which comprises a “Yes” option and a “No” option.

4. The control system of claim 3, wherein the answer signal is selected from the group comprise an approval signal and a rejection signal, when the “Yes” option is selected, the approval signal is issued and sent to the first electronic device; when the “No” option is selected, the rejection signal is issued and sent to the first electronic device.

5. The control system of claim 4, wherein the connection control unit controls the first electronic device to connect to the network when the approval signal is received; and the connection control unit controls the first electronic device to keep disconnecting from the network when the rejection signal is received.

6. An electronic device comprising:
a processor configured to execute instructions of the following unit stored in a memory:
a request unit configured to issue a request signal and send the request signal to a second electronic device;
a connection control unit configured to control the electronic device to connect to a network or keep disconnecting from the network according to an answer signal sent from a second electronic device.

7. The electronic device of claim 6, wherein the electronic device further comprises an information obtaining unit, the information obtaining unit obtains information of the first electronic device, and the request signal comprises the information obtained by the information obtaining unit.

8. The electronic device of claim 6, wherein the answer signal is selected from the group consisting of an approval signal and a rejection signal; when the approval signal is received, the connection control unit controls the electronic device to connect to the network; when the rejection signal is received, the connection control unit controls the electronic device to keep disconnecting from the network.

9. A control method for controlling network connection, the control method comprising:
issuing a request signal and sending the request signal to a second electronic device through a base station;
issuing an answer signal in response to a user's operation and sending the answer signal to a first electronic device;
controlling the first electronic device to connect to a network or keep disconnecting from the network according to the answer signal.

10. The control method of claim 9, wherein the method further comprises obtaining information of the first electronic device, the request signal comprises the obtained information.

11. The control method of claim 10, wherein the method further comprises controlling a display unit to display a message which comprises the obtained information, and at least two options which comprises a “Yes” option and a “No” option.

12. The control method of claim 11, wherein issuing an answer signal in response to a user's operation and sending the answer signal to a first electronic device comprises issuing an approval signal and sending the approval signal to the first electronic device when the “Yes” option is selected; issuing a rejection signal and sending the rejection signal to the first electronic device when the “No” option is selected.

13. The control method of claim 12, wherein controlling the first electronic device to connect to the network or disconnect to the network according to the answer signal comprises controlling the first electronic device to connect to the network when the approval signal is received; controlling the first electronic device to keep disconnecting from the network when the rejection signal is received.
